(19) United States
(12) Patent Application Publication
(10) Pub. No.: US 2016/0054785 A1
(43) Pub. Date: Feb. 25, 2016

(54) POWER CONTROL APPARATUS OF ENERGY STORAGE SYSTEM

(71) Applicant: LG CNS CO., LTD., Seoul (KR)

(72) Inventors: Byeong Kueon CHOI, Seoul (KR); Dong Chul KO, Seoul (KR); Sang Hyub KIM, Seoul (KR); Tae Hyoung RYU, Seoul (KR); Byoung Seung LEE, Seoul (KR); Min Seok CHOI, Seoul (KR); Jae Sam LEE, Seoul (KR); Hyung Jun CHAE, Seoul (KR)

(73) Assignee: LG CNS CO., LTD., Seoul (KR)

(21) Appl. No.: 14/596,108

(22) Filed: Jan. 13, 2015

(30) Foreign Application Priority Data
Aug. 21, 2014 (KR) 10-2014-0109068

(51) Int. Cl. G06F 1/32; G06F 1/26

(52) U.S. Cl. CPC G06F 1/3287; G06F 1/3212; G06F 1/263

(57) ABSTRACT

A power control apparatus of an energy storage system and method of controlling the power control apparatus are provided. The power control apparatus includes a battery manager to monitor a charge state of at least one battery module and to manage charge and discharge of the at least one battery module, a power converter to convert power of the at least one battery module from alternating current (AC) to direct current (DC) or from DC to AC, a controller configured to control the battery manager and the power converter, and a standby power supplier configured to supply constant power to the battery manager, the power converter, and the controller when the battery manager is not driven.

### CROSS-REFERENCE TO RELATED APPLICATION

This application claims the benefit of earlier filing date and right of priority to Korean Patent Application No. 10-2014-0109068, filed on Aug. 21, 2014, the contents of which is incorporated by reference herein in its entirety.

### FIELD OF THE INVENTION

The present invention is related to an energy storage system, and more particularly, to a power control apparatus of an energy storage system.

### DESCRIPTION OF THE RELATED ART

With an increase in energy consumption, technologies for efficiently using energy are under development. An example of such technology may include an energy storage system that may store a large amount of power as energy and supply the stored power to a load.

Korean Laid-Open Publication No. 10-2011-0062852 discloses an energy storage system that includes a plurality of battery packs connected between a system and a solar cell and configured to charge and discharge power. The energy storage system includes a bi-directional inverter connected to a grid between the battery packs and the solar cell and is configured to invert power from alternating current (AC) to direct current (DC) or from DC to AC, a converter connected to the solar cell between the battery packets and the grid and configured to convert a power of the solar cell, a plurality of bi-directional converters connected one-to-one to the battery packs between the solar cell and the grid and configured to convert a charge and discharge power of the battery pack, and a controller connected and configured to apply a driving signal to the bi-directional inverter, the converter, and the bi-directional converters and to sequentially drive the bi-directional converters.

However, the disclosed energy storage system supplies energy in a stationary state and has disadvantages if provided in a mobile system. Accordingly, the energy storage system may be inappropriate for mounting to a movable unit to supply energy.

### SUMMARY OF THE INVENTION

In one aspect of the present invention, a power control apparatus of an energy storage system is provided. The power control apparatus includes a battery manager configured to monitor a charge state of at least one battery module and to manage charge and discharge of the at least one battery module, a power converter configured to convert power of the at least one battery module from alternating current (AC) to direct current (DC) or from DC to AC, a controller configured to control the battery manager and the power converter, and a standby power supplier configured to supply constant power to the battery manager, the power converter, and the controller when the battery manager is not driven.

It is contemplated that the standby power supplier is further configured to convert power of the at least one battery module to the constant power. It is further contemplated that the standby power supplier is further configured to generate the constant power using a switched-mode power supply method.

It is contemplated that the standby power supplier includes a switcher configured to switch DC power of the at least one battery module to AC power, a transformer configured to transform the AC power and a rectifier configured to rectify the AC power to DC power. It is further contemplated that the standby power supplier includes a step-down conversion circuit configured to generate the constant power via a voltage step-down of the at least one battery module.

It is contemplated that the standby power supplier is further configured to sequentially drive the power converter, the battery manager, and the controller with the supplied constant power. It is further contemplated that the apparatus further includes a switch configured to drive the standby power supplier in response to a user input.

It is contemplated that the energy storage system is fixed to a movable unit and configured to supply energy to the movable unit. It is further contemplated that the power converter includes at least a converter, inverter, bi-directional converter, or bi-directional inverter configured to convert the power of the at least one battery module. Moreover. it is contemplated that the battery production manager is further configured to perform at least a protection control function, lifecycle control function or charge and discharge control function of the at least one battery module.

In another aspect of the present invention, an operation method of a power control apparatus of an energy storage system is provided. The method includes monitoring a charge state of at least one battery module and managing charge and discharge of at the least one battery module by a battery manager, converting power of the at least one battery module from alternating current (AC) to direct current (DC) or from DC to AC, and supplying constant power to the battery manager when the battery manager is not driven.

It is contemplated that the method further includes converting power of the at least one battery module to the constant power. It is further contemplated that the method further includes generating the constant power using a switched-mode power supply method.

It is contemplated that supplying the constant power includes switching DC power of the at least one battery module to AC power, transforming the AC power and rectifying the transformed AC power to DC power. It is further contemplated that the method further includes generating the constant power vi a voltage step-down of the at least one battery module.

It is contemplated that the method further includes sequentially driving the battery manager, a power converter, and a controller with the supplied constant power, the power converter converting power of the at least one battery module and the controller controlling the battery manager and the power converter. It is further contemplated that the method further includes receiving a user input for supplying the standby power and supplying the constant power in response to the user input.

It is contemplated that the energy storage system is fixed to a movable unit and configured to supply energy to the movable unit. It is further contemplated that converting the power of the at least one battery module includes controlling at least a converter, an inverter, a bi-directional converter, or a bi-directional inverter. Moreover, it is contemplated that the the battery manager performs at least a protection control function, lifecycle prediction control function or charge and discharge control function of the at least one battery module.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an energy storage system according to an embodiment of the present invention;

FIG. 2 illustrates a block diagram of a power control apparatus according to an embodiment of the present invention;

FIG. 3 illustrates a block diagram of the standby power supplier illustrated in FIG. 2;

FIG. 4 illustrates a circuit diagram of a standby power supplier according to an embodiment of the present invention; and

FIG. 5 illustrates a flowchart of an operation method of a power control apparatus according to an embodiment of the present invention.

### DETAILED DESCRIPTION OF THE INVENTION

Reference will now be made in detail to embodiments, examples of which are illustrated in the accompanying drawings, wherein like reference numerals refer to like elements throughout. Embodiments of the present invention are described by referring to the figures.

Various alterations and modifications may be made to the embodiments. The embodiments are not construed as limited to the disclosure and should be understood to include all changes, equivalents, and replacements within the idea and the technical scope of the disclosure.

The terminology used herein is for the purpose of describing particular embodiments only and is not intended to limit the embodiments. As used herein, the singular forms “a”, “an”, and “the” are intended to include the plural forms as well, unless the context clearly indicates otherwise. It will be further understood that the use of terms “include/comprise” and/or “have” specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms including technical and scientific terms used herein have the same meaning as commonly understood by one of ordinary skill in the art to which the present invention belongs. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments of the present invention with reference to the accompanying drawings, like reference numerals refer to like constituent elements and a repeated related description will be omitted. When it is determined that detailed description related to a known functions or configurations may make the description and purpose of the embodiments unnecessarily ambiguous, the detailed description will be omitted.

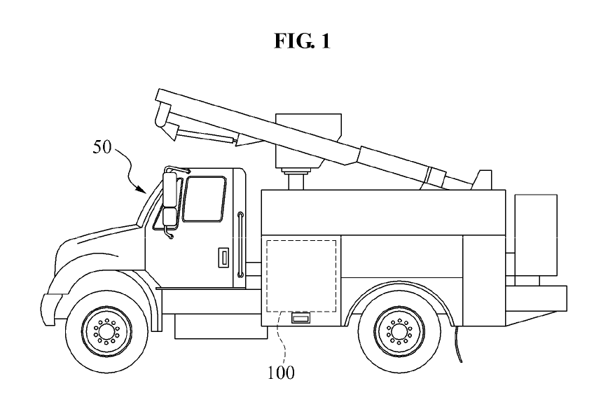

FIG. 1 illustrates an energy storage system 100 according to an embodiment of the present invention. As illustrated in FIG. 1, the energy storage system 100 includes a movable unit 50.

The movable unit 50 may be a vehicle, a ship, or heavy equipment. The movable unit may provide a specific function such as a ladder truck, a camping car, a cold storage car, a sprinkler truck, a ready-mix truck, an excavator, a forklift, or a crane. The energy storage system 100 may supply the movable unit with energy for the specific function.

In the related art, fossil fuel has been used for energy of the movable unit 50. An engine of the movable unit must be operated in order to provide the corresponding specific function and, therefore, carbon emission and noise occur due to use of the fossil fuel. In addition, energy efficiency of the specific function is subordinate to the energy efficiency of the engine of the movable unit. Therefore, when the engine of the movable unit has low energy efficiency, the corresponding specific function may also have low energy efficiency.

According to embodiments of the present invention, a specific function of the movable unit 50 is driven according to the energy storage system 100 and, therefore, carbon emission and noise generated by the specific function may be reduced. Also, the specific function may have high energy efficiency according to an increase in energy efficiency of the energy storage system.

When the energy storage system 100 cannot normally operate through a battery management system (BMS), a power control apparatus 200 may supply standby power to the energy storage system 100. The energy storage system may be stably supplied with energy through the power control apparatus.

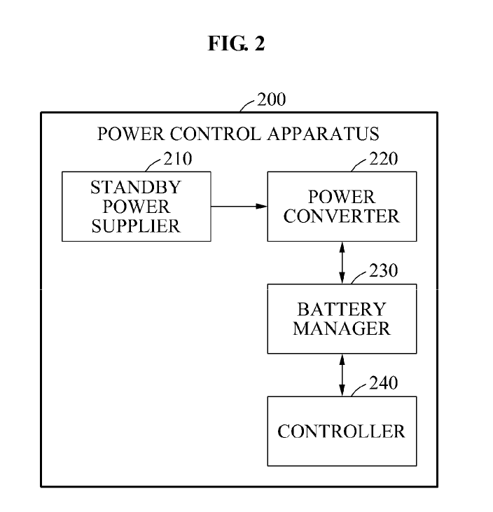

FIG. 2 illustrates a block diagram of a power control apparatus 200 according to an embodiment of the present invention. As illustrated in FIG. 2, the power control apparatus includes a standby power supplier 210, a power converter 220, a battery manager 230, and a controller 240.

The power converter 220 converts input/output power of at least one battery module from alternating current (AC) to direct current (DC) or from DC to AC using at least a coverer, an inverter, a bi-directional converter, or a bi-directional inverter. The power converter may convert DC power output from the battery module to AC power and may transfer the converted AC power to a grid and a load. The power converter may also perform DC-AC bi-directional transmission by converting the converted AC power back to DC power and transferring the converted DC power to the battery module.

The battery manager 230 monitors a charge state of at least one battery module and manages charge and discharge of the at least one battery module. The battery manager may perform a protection control function, lifecycle prediction control function, or charge and discharge control function of the battery module so that the battery module may attain maximum performance and be safely used.

The controller 240 determines whether charge and discharge of at least one battery module is to be performed and whether power conversion is to be performed by the power converter 220 and transfers at least one control signal to the battery manager 230, the power converter, and the movable unit 50 based on the determination. The controller may form a network using a controller area network (CAN) protocol with the battery manager, the power converter, and the moving unit.

The standby power supplier 210 supplies constant power to the battery manager 230 and the power converter 220 when the battery manager is not driven. The energy storage system 100 may be supplied with power from at least one battery module managed by the battery manager and may be supplied with power from the standby power supplier when the battery manager is not driven. The energy storage system 100 may be stably supplied with power via the standby power supplier.

The standby power supplier 210 may convert power charged in the at least one battery module to constant power and may supply the constant power to the battery manager 230 and the power converter 220. The standby power supplier may also supply the battery manager and the power converter with constant power separately provided from the battery module in order to supply standby power.

The standby power supplier 210 may generate constant power using a switched-mode power supply method. The switched-mode power supply method refers to using a switching circuit as a single method of a power apparatus.

The standby power supplier 210 may include a step-down conversion circuit, such as a Buck converter configured to step down high-voltage DC power of the battery module to low voltage DC power. The standby power supplier may generate constant power via power step-down of the battery module instead of using the switched-mode power supply method.

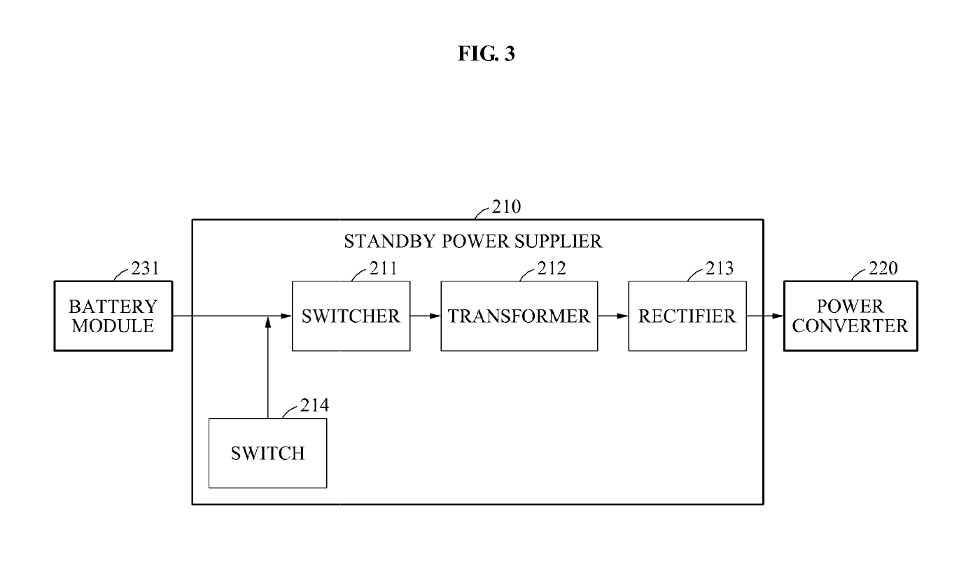

The standby power supplier 210 may supply power in a form of an LLC resonant converter topology. The standby power supplier may be installed in a protection relay box of the energy storage system 100. The standby power supplier will be described further with reference to FIG. 3.

FIG. 3 illustrates a block diagram of the standby power supplier 210 illustrated in FIG. 2. AS illustrated in FIG. 3, the standby power supplier includes a switcher 211, a transformer 212, and a rectifier 213. The standby power supplier may also include a switch 214.

The switcher 211 converts DC power of at least one battery module 231 to AC power. The switcher may convert DC power of the battery module to AC power by alternately switching two transistors.

The transformer 212 transforms the converted AC power. The transformer may transform an output voltage of the battery module 231 to a voltage available at the power converter 220. For example, the transformer may transform a 210 V to 290.5 V voltage of the battery module 231 to 12 V or 24 V available at the power converter.

The rectifier 213 rectifies the converted AC power to DC power. The standby power supplier 210 may also include the switch 214, a smoothing circuit, or a filter.

The switch 214 drives the standby power supplier 210 in response to a user input. The switch may be exposed externally from the energy storage system 100 in order to receive the user input.

The standby power supplier 210 generates constant power from at least one battery module 231 managed by the battery manager 230 and may supply the generated constant power to the transformer 212. The transformer, the battery manager, and the controller 240 may be sequentially driven by the constant power. The controller may be driven sequentially after the power transformer and the battery manager are driven.

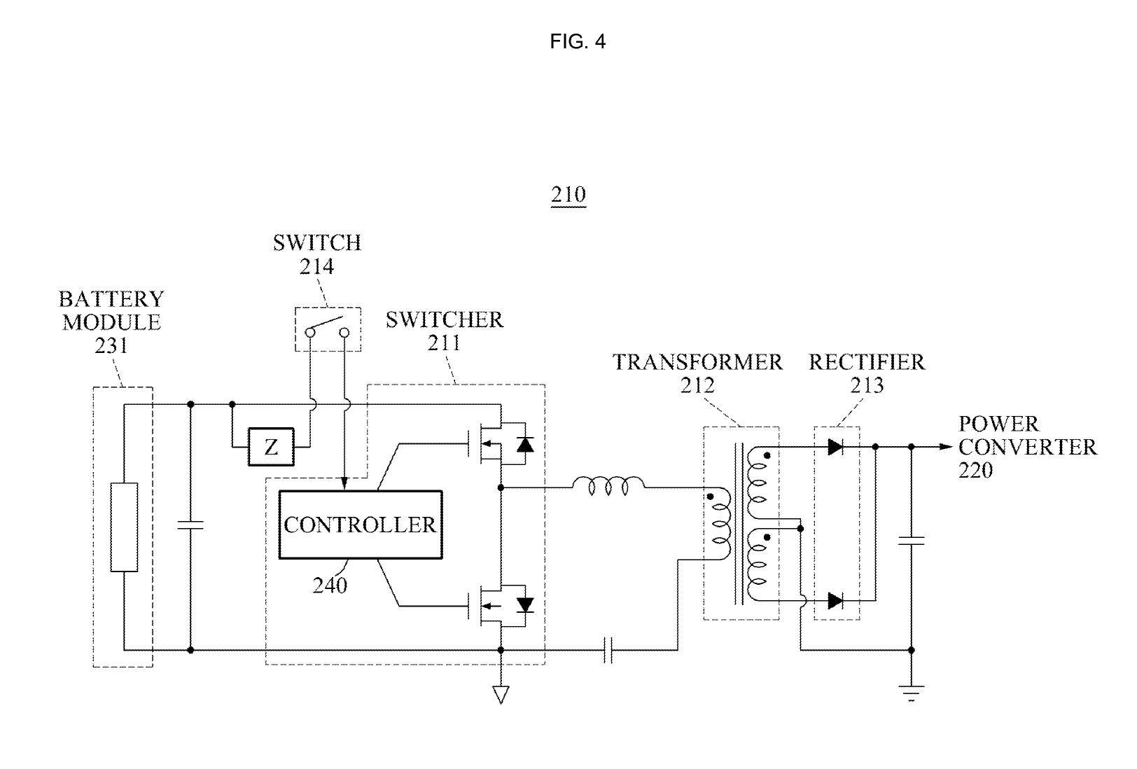

FIG. 4 illustrates a circuit diagram of the standby power supplier 210 according to an embodiment of the present invention. As illustrated in FIG. 4, the standby power supplier includes the at least one battery module 231, the switcher 211, the transformer 212, the rectifier 213, the switch 214, and the power transformer 220. Constant power generated by the standby power supplier 210 is input to the power converter 220.

When the switch 214 is shorted in response to a user input, the switcher 211 converts DC power of the at least one battery module 231 to AC power. The at least one battery module may be managed by a battery manager 230 or be a battery separately provided for standby power.

The switcher 211 may include two transistors and the controller 240 and a filter may be located between the switcher and the transformer. A smoothing circuit may be located at an output end of the rectifier 213.

The transformer 212 may transform AC power output by the switcher 211 to power available at the power converter 220. The rectifier 213 rectifies AC power output by the transformer to DC power.

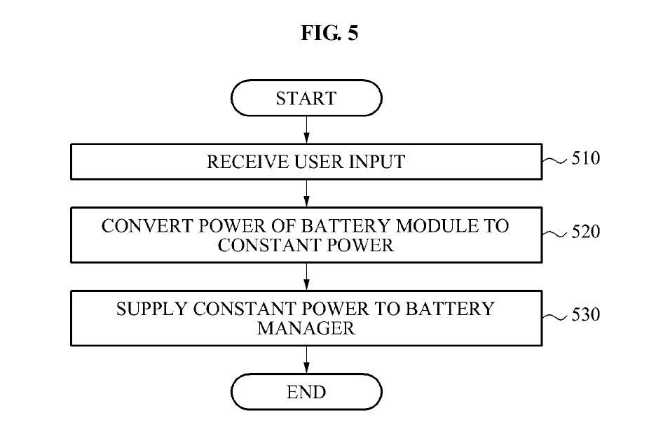

FIG. 5 illustrates a flowchart of an operation method of the power control apparatus 200 according to an embodiment of the present invention. As illustrated in FIG. 5, the power control apparatus 200 receives a user input in operation 510. The user input may be an input for supplying standby power when a battery manager 230 that manages charge and discharge of at least one battery module 231 is not driven.

The power control apparatus 200 converts power of at least one battery module 231 to constant power in operation 520. The power conversion may be performed in response to the user input. The constant power may be generated using a switched-mode power supply method. Operation 520 may include converting DC power of at least one battery module 231 to AC power, transforming the AC power, and rectifying the transformed AC power to DC power.

The power control apparatus 200 supplies constant power to a battery manager 230 in operation 530. The constant power may be sequentially supplied to the battery manager, the power converter 220, and the controller 240. The power converter may convert of input/output power of at least one battery module 231 and the controller may control the battery manager and the power converter.

According to the disclosed embodiments, an energy storage system is provided that is fixed to a movable unit to stably supply energy to the movable unit.

According to the disclosed example embodiments, a power control apparatus of an energy storage system is provided that provides constant power when a battery manager is not driven.

The disclosed embodiments of the present invention may be recorded in non-transitory computer-readable media including program instructions to implement various operations embodied by a computer. The media may also include, alone or in combination with the program instructions, data files, data structures, and the like.

Examples of non-transitory computer-readable media include magnetic media such as hard disks, floppy disks, and magnetic tape; optical media such as CD ROM disks and DVDs; magneto-optical media such as floptical disks; and hardware devices that are specifically configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although example embodiments of the present invention have been illustrated and described, the present invention is not limited to the disclosed embodiments. It will be appreciated by those skilled in the art that changes may be made to the disclosed embodiments without departing from the principles and spirit of the present invention, the scope of which is defined by the claims and their equivalents.

What is claimed is:

1. A power control apparatus of an energy storage system, the power control apparatus comprising:
a battery manager configured to monitor a charge state of at least one battery module and to manage charge and discharge of the at least one battery module;
a power converter configured to convert power of the at least one battery module from alternating current (AC) to direct current (DC) or from DC to AC;
a controller configured to control the battery manager and the power converter; and
a standby power supplier configured to supply constant power to the battery manager, the power converter, and the controller when the battery manager is not driven.

2. The power control apparatus of claim 1, wherein the standby power supplier is further configured to convert power of the at least one battery module to the constant power.

3. The power control apparatus of claim 1, wherein the standby power supplier is further configured to generate the constant power using a switched-mode power supply method.

4. The power control apparatus of claim 1, wherein the standby power supplier comprises:
a switcher configured to switch DC power of the at least one battery module to AC power;
a transformer configured to transform the AC power; and
a rectifier configured to rectify the AC power to DC power.

5. The power control apparatus of claim 1, wherein the standby power supplier comprises a step-down conversion circuit configured to generate the constant power via a voltage step-down of the at least one battery module.

6. The power control apparatus of claim 1, wherein the standby power supplier is further configured to sequentially drive the power converter, the battery manager, and the controller with the supplied constant power.

7. The power control apparatus of claim 1, further comprising:
a switch configured to drive the standby power supplier in response to a user input.

8. The power control apparatus of claim 1, wherein the energy storage system is fixed to a movable unit and configured to supply energy to the movable unit.

9. The power control apparatus of claim 1, wherein the power converter comprises at least a converter, inverter, bi-directional converter, or bi-directional inverter configured to convert the power of the at least one battery module.

10. The power control apparatus of claim 1, wherein the battery production manager is further configured to perform at least a protection control function, lifecycle control function or charge and discharge control function of the at least one battery module.

11. An operation method of a power control apparatus of an energy storage system, the method comprising:
monitoring a charge state of at least one battery module and managing charge and discharge of at the least one battery module by a battery manager;
converting power of the at least one battery module from alternating current (AC) to direct current (DC) or from DC to AC; and
supplying constant power to the battery manager when the battery manager is not driven.

12. The method of claim 11, further comprising converting power of the at least one battery module to the constant power.

13. The method of claim 11, further comprising generating the constant power using a switched-mode power supply method.

14. The method of claim 11, wherein supplying the constant power comprises:
switching DC power of the at least one battery module to AC power;
transforming the AC power; and
rectifying the transformed AC power to DC power.

15. The method of claim 11, further comprising generating the constant power vi a voltage step-down of the at least one battery module.

16. The method of claim 11, further comprising sequentially driving the battery manager, a power converter, and a controller with the supplied constant power, the power converter converting power of the at least one battery module and the controller controlling the battery manager and the power converter.

17. The method of claim 11, further comprising:
receiving a user input for supplying the standby power; and
supplying the constant power in response to the user input.

18. The method of claim 11, wherein the energy storage system is fixed to a movable unit and configured to supply energy to the movable unit.

19. The method of claim 11, wherein converting the power of the at least one battery module comprises controlling at least a converter, an inverter, a bi-directional converter, or a bi-directional inverter.

20. The method of claim 11, wherein the battery manager performs at least a protection control function, lifecycle prediction control function or charge and discharge control function of the at least one battery module.
